(19) United States
(12) Patent Application Publication
(10) Pub. No.: US 2014/0373729 A1
(43) Pub. Date: Dec. 25, 2014

(54) ELECTRIC RICE COOKER

(71) Applicants: Cha Sik KIM, (US); Kwang Soon JUNG, (US); Dong Hyun KIM, Yeongdeungpo-gu Seoul (KR)

(72) Inventors: Cha Sik Kim, Seoul (KR); Kwang Soon Jung, Seoul (KR); Dong Hyun Kim, Seoul (KR)

(21) Appl. No.: 14/376,566

(22) PCT Filed: Jan. 29, 2013
(86) PCT No.: PCT/KR2013/000719

§ 371 Date: Aug. 4, 2014

(30) Foreign Application Priority Data
Feb. 7, 2012 (KR) 10-2012-0012359

(51) Int. Cl. A47J 27/00

(52) U.S. Cl. CPC A47J 27/004
USPC 99/403

(57) ABSTRACT

Electric rice cooker comprises: an upper casing unit having a valve unit discharging pressure; an inner bowl arranged beneath the upper casing unit and containing food; a heat insulating outer bowl enclosing the inner bowl and forming a first heat sustaining space between the inner and outer bowls; a lower casing unit enclosing the heat insulating outer bowl and having air supply ports; a lower heating unit, interposed between the heat insulating outer bowl and the inner bowl, for generating heat; an upper heater unit arranged inside the upper casing unit to operate with the lower heater unit; a vacuum packing unit interposed between the upper casing unit and the inner bowl to cut off air flow; a stopper groove formed along an edge of the upper casing unit facing the inner bowl; and a stopper protrusion for causing the vacuum packing unit to be caught at the stopper groove.

### TECHNICAL FIELD

The present invention relates to an electric rice cooker, and more particularly, to an electric rice cooker which can easily control cooking pressure inside an inner bowl and preserve food stored in the electric rice cooker for a long time because it prevents outside air from introducing into the inner bowl and the inside of the inner bowl keeps at a low pressure state even after cooking.

### BACKGROUND ART

In general, an electric rice cooker is a cooking device for cooking rice or food using heat generated by electric resistance.

When a user puts food ingredients, such as rice, in a main body part and closes a lid, the electric rice cooker applies electric heat to the bottom side part to cook food.

Such a conventional electric rice cooker includes a valve for discharging steam, and the valve serves to simply discharge steam or stop discharge of steam.

It is demanded to control steam pressure discharged after heating cooking of the electric rice cooker according to kinds of cooked food and according to users' tastes, but such a valve of the conventional electric rice cooker cannot satisfy such a demand.

Moreover, the conventional electric rice cooker has a disadvantage in that there is high probability of pollution of food and deterioration in preservation performance of food because the outside air containing germs is introduced into the electric rice cooker through the valve which is opened after discharge of steam and the inside air of the electric rice cooker cannot keep the low pressure state.

As a background art of the present invention, Korean Patent publication No. 2011-0095995 published on Aug. 26, 2011 discloses a full automatic electric rice cooker.

### DISCLOSURE

### Technical Problem

Accordingly, the present invention has been made in an effort to solve the above-mentioned problems occurring in the prior arts, and it is an object of the present invention to provide an electric rice cooker which can prevent an increase of user's inconvenience by controlling steam pressure discharged according to a user's tastes or according to kinds of foods.

It is another object of the present invention to provide an electric rice cooker which can prevent deterioration in preservation of food by preventing outside air from introducing into the electric rice cooker while storing food in the rice cooker and keeping the inside of the rice cooker at a low pressure state.

### Technical Solution

To achieve the above objects, the present invention provides an electric rice cooker including: an upper casing unit on which a valve unit for discharge pressure is mounted; an inner bowl which is arranged beneath the upper casing unit and in which food to be cooked is contained; a heat insulating outer bowl enclosing an outer surface of the inner bowl and having a first heat sustaining space formed between the inner bowl and the outer bowl; a lower casing unit enclosing an outer surface of the heat insulating outer bowl and having a plurality of air supply ports; a lower heating unit interposed between the heat insulating outer bowl and the inner bowl for generating heat; an upper heater unit arranged inside the upper casing unit to operate together with the lower heater unit; a vacuum packing unit interposed between the upper casing unit and the inner bowl to cut off an air flow; and a stopper protrusion which has a stopper groove formed along an edge of the upper casing unit facing the inner bowl in such a way that the vacuum packing unit is inserted and caught at the stopper groove, wherein the vacuum packing unit includes: a lid separation preventing member inserted and caught to the stopper groove; a bowl outside separation preventing member which extends from the lid separation preventing member and is caught to the outside of the inner bowl; and an interior sealing member connected to the lid separation preventing member and the bowl outside separation preventing member, extended toward the inside of the inner bowl, and mounted between the inner bowl and the stopper protrusion.

Moreover, the upper casing unit includes: an inner lid which is mounted above the inner bowl and has the stopper protrusion disposed at the edge thereof; a heat reflection plate which is spaced apart from the inner lid to form a second concurrent heating space and has a lower side to which the upper heater unit is mounted; a heat insulating plate enclosing an outer surface of the heat reflection plate to prevent heat transfer; and a lid case enclosing an outer surface of the heat insulating plate.

Furthermore, the vacuum packing unit includes a plurality of sealing protrusions which protrudes from the side of the interior sealing member facing the inner bowl and is mounted to get in contact with the side of the inner bowl.

Additionally, the valve unit includes: a main valve which is mounted by passing through the upper casing unit, rotates the housing member by the valve handgrip, varies the height of a fixing member to thereby control discharge pressure of steam, and is automatically seated on a second sealing plate auto after discharge of predetermined pressure to thereby keep a sealed state of the inner bowl.

In addition, the main valve includes: a height controlling unit having teeth of which height is gradually increased is disposed inside the housing member in such a way that the valve handgrip protrudes from one side to control pressure; fixing protrusions mounted inside the housing member and protrudingly formed from the fixing member to interlock with the teeth of the height controlling unit; a pressure member including a support plate pressurized downwardly by a spring member disposed inside the fixing member and a vertical bar upwardly protruding from the center of the support plate and passing through the center of the fixing member to indicate a pressure state signal; a movement member in which the pressure member is seated in such a way as to receive pressing power by the spring member and which is mounted inside the housing member; an upper sealing member which is fixed at the lower side of the movement member to be moved according to an up and down movement of the movement member and has a first sealing plate disposed at the lower side; and a lower sealing member which is located at the lower side of the upper sealing member and has a pressure discharge hole communicating with the inside of the inner bowl, wherein the steam discharged through the pressure discharge hole is discharged out by passing through a side steam discharge groove formed in the movement member, a first central steam discharge groove formed in the fixing member and a second central steam discharge groove formed in the housing member in order.

Moreover, the valve unit includes a subsidiary valve for automatically discharging steam at set pressure exceeding discharge pressure of the main valve, and the subsidiary valve includes: a body member which is fixed at the upper casing unit and includes a steam inlet communicating with the inside of the inner bowl, an outlet communicating with the outside of the upper casing unit, and an operation space communicating with the steam inlet and the outlet; a cylinder member sliding along the operation space according to steam pressure; and an elastic member of which both sides are supported to the body member and the cylinder member and which downwardly presses the cylinder member by a predetermined elastic force toward the lower side where the steam inlet is formed.

Furthermore, the electric rice cooker further includes: a plurality of connection through holes formed in the heat insulating outer bowl; and a bimetal member varied in length according to a change in temperature of the first heat sustaining space to open and close the connection hole.

Additionally, the electric rice cooker further includes: a hot plate member which is mounted between the lower heater unit and the inner bowl and distributes heat of the lower heater unit to heat the lower side of the inner bowl.

### Advantageous Effects

The electric rice cooker according to the embodiment of the present invention can control discharged steam pressure by rotating a valve handgrip, thereby providing various cooking conditions according to the user's tastes and kinds of foods.

Furthermore, the electric rice cooker according to the embodiment of the present invention can prevent movement of air inside and outside the electric rice cooker through the main valve or the subsidiary valve for discharging steam and keep a low pressure and low vacuum state which is formed after the inside air of the electric rice cooker is cooled down at a high temperature state while storing food therein, thereby enhancing food preserving performance.

### DESCRIPTION OF DRAWINGS

FIG. 1 is a brief sectional view showing an electric rice cooker according to a preferred embodiment of the present invention.

FIG. 2 is an exploded perspective view of a main valve of the electric rice cooker.

FIG. 3 is a side sectional view showing a state of a spring member before it is pressed from the main valve shown in FIG. 2.

FIG. 4 is a side sectional view showing a state of the spring member after it is pressed from the main valve shown in FIG. 2.

FIG. 5 is a sectional view showing a state where inside steam of the electric rice cooker is discharged out while pushing up the main valve.

FIG. 6 is a brief sectional view showing a mounted state of a vacuum packing part.

FIG. 7 is a brief sectional view showing an operational state of a bimetal member.

FIG. 8 is a brief sectional view showing an operational state of a subsidiary valve.

### MODE FOR INVENTION

Hereinafter, referring to the attached drawings, an electric rice cooker according to a preferred embodiment of the present invention will be described. For convenience in description, an electric rice cooker for home use as an example will be described. It will be understood that thickness of lines or sizes of components illustrated in the drawings may be exaggerated for purposes of clarity in description and for convenience sake. Moreover, it will be also understood that terms which will be used in the specification to describe are terms defined in consideration of functions of the present invention and may be changed according to users' or operators' intentions or according to customs. Therefore, such terms should be defined based on the all-around contents of this specification.

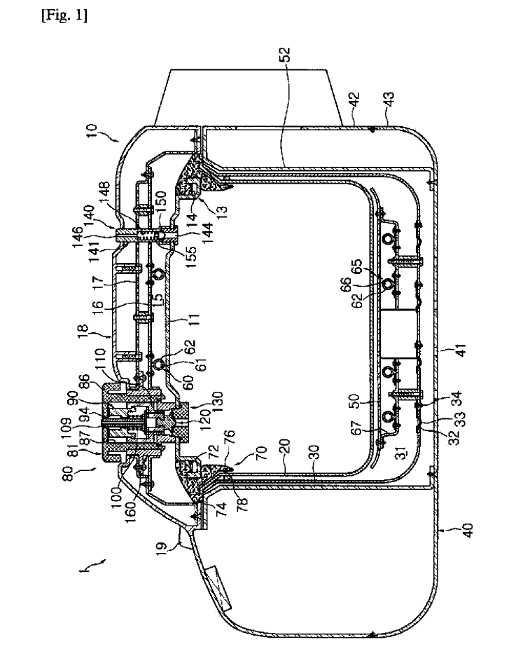

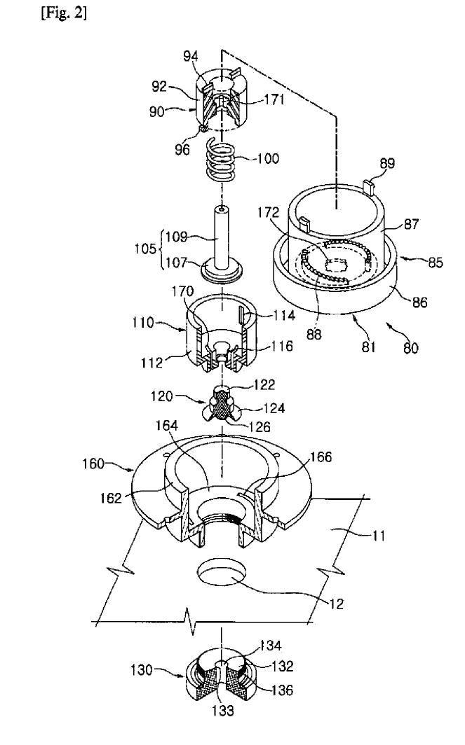

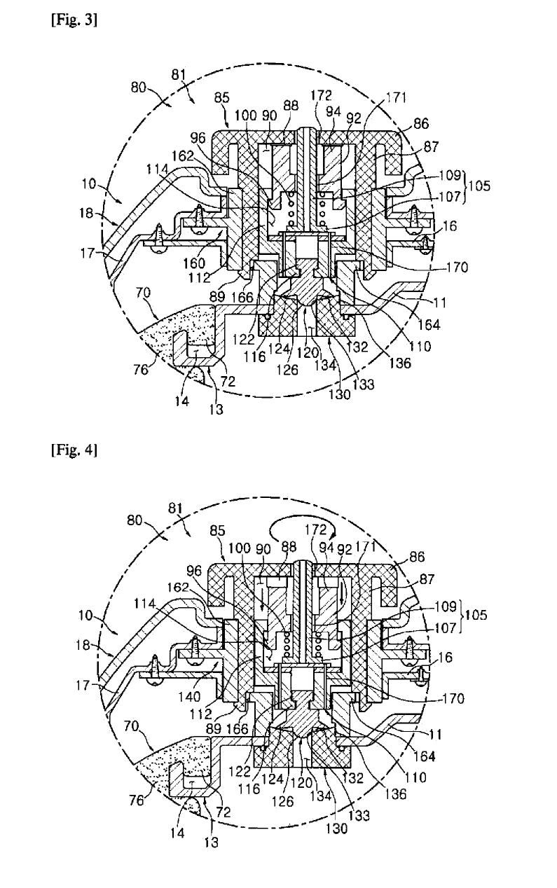

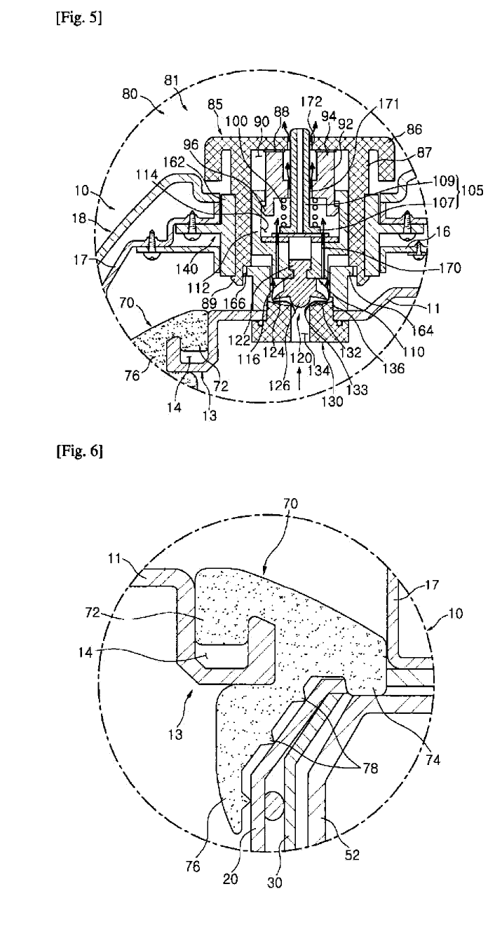

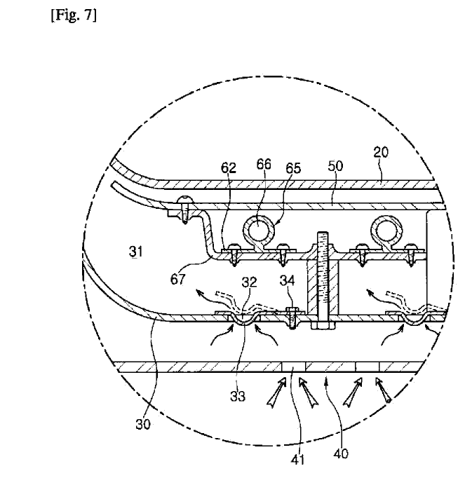

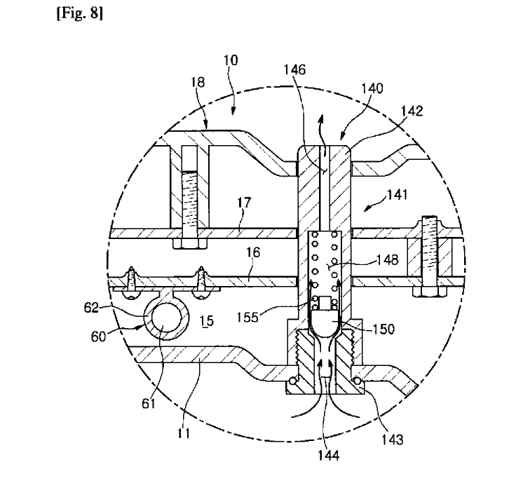

FIG. 1 is a brief sectional view showing an electric rice cooker according to a preferred embodiment of the present invention, FIG. 2 is an exploded perspective view of a main valve of the electric rice cooker, FIG. 3 is a side sectional view showing a state of a spring member before it is pressed from the main valve shown in FIG. 2, FIG. 4 is a side sectional view showing a state of the spring member after it is pressed from the main valve shown in FIG. 2, FIG. 5 is a sectional view showing a state where inside steam of the electric rice cooker is discharged out while pushing up the main valve, FIG. 6 is a brief sectional view showing a mounted state of a vacuum packing part, FIG. 7 is a brief sectional view showing an operational state of a bimetal member, and FIG. 8 is a brief sectional view showing an operational state of a subsidiary valve.

As shown in FIGS. 1 to 8, the electric rice cooker 1 according to the preferred embodiment of the present invention includes: an upper casing unit 10 on which a valve unit 80 for discharge pressure is mounted; an inner bowl 20 which is arranged beneath the upper casing unit 10 and in which food to be cooked is contained; a heat insulating outer bowl 30 enclosing an outer surface of the inner bowl 20 and having a first heat sustaining space 31 formed between the inner bowl 20 and the outer bowl 30; a lower casing unit 40 enclosing an outer surface of the heat insulating outer bowl 30 and having a plurality of air supply ports 41; a lower heating unit 65 interposed between the heat insulating outer bowl 30 and the inner bowl 20 for generating heat; an upper heater unit 60 arranged inside the upper casing unit 10 to operate together with the lower heater unit 65; a vacuum packing unit 70 interposed between the upper casing unit 10 and the inner bowl 20 to cut off an air flow; and a stopper protrusion 13 which has a stopper groove 14 formed along an edge of the upper casing unit 10 facing the inner bowl 20 in such a way that the vacuum packing unit 70 is inserted and caught at the stopper groove 14.

The upper casing unit 10 which forms the upper part of the electric rice cooker 1 includes: an inner lid 11 which is mounted above the inner bowl 20 and has the stopper protrusion 13 disposed at the edge thereof; a heat reflection plate 16 which is spaced apart from the inner lid 11 to form a second concurrent heating space 15 and has a lower side to which the upper heater unit 60 is mounted; a heat insulating plate 17 enclosing an outer surface of the heat reflection plate 16 to prevent heat transfer; and a lid case 18 enclosing an outer surface of the heat insulating plate 17.

The inner lid 11 is mounted to come into contact with the upper side of the inner bowl 20 and may be molded of a material with high heat conductivity in order to easily transfer heat of the upper heater part 60 to the inside of the inner bowl 20.

Such an inner lid 11 includes a first connection hole 12 to mount a main valve 81 therein and a second connection hole (not shown) to mount a subsidiary valve 140 therein.

The stopper protrusion 13 of which upper side is opened along the edge of the inner lid 11 forms the stopper groove 14, and a part of the vacuum packing unit 70 is inserted into the stopper protrusion 13.

A heat reflection plate 16 is mounted above the inner lid 11, and the upper heater unit 60 is mounted beneath the heat reflection plate 16.

The upper heater unit 60 includes an upper heater 61 for generating heat through supply of electric power and a heater bracket 62 for fixing the upper heater 61 to the heat reflection plate 16.

The heat reflection plate 16 reflects heat generated from the upper heater 61 in the downward direction where the inner bowl 20 is mounted in order to enhance thermal efficiency of the upper heater unit 60.

A heat insulating plate 17 is mounted above the heat reflection plate 16 to prevent that heat of the upper heater unit 60 is transferred to a lid case 18 which is made of a plastic material.

The lid case 18 enclosing an outer surface of the heat reflection plate 16 forms the outward appearance of the upper casing unit 10.

Opening and closing buttons 19 are mounted at one side of the upper casing unit 10, and a user manipulates the opening and closing buttons 19 to move the upper casing unit 10.

Such an opening and closing structure of the upper casing unit 10 has been well known to those skilled in the art, and hence its detailed description will be omitted.

The electric rice cooker 1 according to the preferred embodiment of the present invention includes a heat insulating outer bowl 30 mounted inside the lower casing unit 40, and the inner bowl 20 in which food ingredients to be cooked is contained is mounted inside the outer bowl 30.

The upper casing unit 10 is mounted above the inner bowl 20 in order to open and close the upper side of the inner bowl 20, and is hinge-coupled to the lower casing unit 40.

The lower casing unit 40 may have a single structure that includes only the inner bowl 20, but the present invention is not limited to the above. The lower casing unit 40 may have not only the double structure in which the heat insulating outer bowl 30 and the inner bowl 20 are combined but also a triple structure or one of other multiple structures.

In a case that the lower casing unit 40 has the double structure, the first heat sustaining space 31 is formed between the heat insulating outer bowl 30 and the inner bowl 20.

Through the above structure, heat generated from the lower heater unit 65 is not directly transferred to food but is transferred to food through the first heat sustaining space 31, such that the upper side and the lower side of food contained in the electric rice cooker 1 are in a thermal equilibrium state.

The first heat sustaining space 31 is formed between the heat insulating outer bowl 30 and the inner bowl, and includes a predetermined space formed beneath the bottom side of the inner bowl 20, and a first heat sustaining space 31 is further formed at a part of the outer side of the inner bowl 20.

That is, in a case that heater directly gets in contact with the lower part of the inner bowl 20 to transfer heat, the lower part of the inner bowl 20 which has a heat source is in a relatively high temperature state, but the upper part of the inner bowl 20 which is far from the heat source is in a relatively low temperature state, and hence, the upper part and the lower part of the inner bowl 20 are not in the thermal equilibrium state.

However, when the first heat sustaining space 31 is formed between the heat insulating outer bowl 30 and the inner bowl 20 of the electric rice cooker 1, heat generated from the lower heater unit 65 heats a hot plate member 50, and at the same time, heats the inside air of the first heat sustaining space 31.

Hot air of the hot plate member 50 and the first heat sustaining space 31 evenly heat the inner bowl 20, the upper part and the lower part of food contained in the inner bowl 20 are in the thermal equilibrium state, so that the electric rice cooker can cook food in good quality.

It is preferable that the inner bowl 20 be made of a copper-containing metal material with high heat transfer efficiency, and the inner bowl 20 which is made of such a copper-containing metal material can keep the thermal equilibrium between the upper part and the lower part better.

The heat insulating outer bowl 30 includes a plurality of connection through holes 32 formed at the lower part, and the connection holes 32 are opened and closed by a bimetal member 33.

The bimetal member 33 is varied in length according to a change in temperature of the first heat sustaining space 31 to open and close the connection hole 32, and is fixed to the heat insulating outer bowl 30 by a bimetal fastening bolt 34.

A heat insulating member 52 is mounted outside the heat insulating outer bowl 30 to prevent heat moved to the outside of the heat insulating outer bowl 30 from being transferred to the lower casing unit 40 and to reduce a thermal loss of the heat insulating outer bowl 30.

Such a heat insulating member 52 is formed in a cylindrical shape, encloses an outer surface of the heat insulating outer bowl 30 and is fixed on the bottom side of the lower casing unit 40.

The lower casing unit 40 which encloses the outer surface of the heat insulating outer bowl 30 or the heat insulating member 52 forms the lower part of the electric rice cooker 1.

The lower casing unit 40 has the air supply ports 41 formed in the bottom side thereof, and the outside air moved to the air supply ports 41 can be moved into the first heat sustaining space 31 through the connection holes 32 formed in the heat insulating outer bowl 30.

The lower casing unit 40 may have a single form and is divided into a lower part upper plate 42 and a lower part lower plate 43 which may be combined by fixing means.

The hot plate member 50 mounted between the lower heater unit 65 and the inner bowl 20 may be formed in various shapes within the technical scope to distribute heat of the lower heater unit 65 to heat the lower part of the inner bowl 20.

The hot plate member 50 according to the preferred embodiment of the present invention is mounted in such a manner that the inner bowl 20 is spaced apart from the lower part of the hot plate member 50, and is connected to the lower heater unit 65.

Because the lower heater unit 65 is fixed at the bottom surface of the heat insulating outer bowl 30, the hot plate member 50 and the lower heater unit 65 are fixed between the heat insulating outer bowl 30 and the inner bowl 20.

The lower heater unit 65 includes: a lower heater supporting panel 67 fixed to the heat insulating outer bowl 30; and a heater bracket 62 for fixing the lower heater 66 to the lower heater supporting panel 67.

The lower heater unit 65 heats the hot plate member 50, and at the same time, heats the inside air of the first heat sustaining space 31 so as to heat the inner bowl 20 by radiant heat and convection current heat.

The vacuum packing unit 70 connected to the inner lid 11 of the upper casing unit 10 is formed in a ring shape, one side (right side in FIG. 1) of the vacuum packing unit 70 is caught and fixed to the outer edge of the inner bowl 20.

The vacuum packing unit 70 according to the preferred embodiment includes: a lid separation preventing member 72 inserted and caught to the stopper groove 14; a bowl outside separation preventing member 74 extending from the lid separation preventing member 72 and caught to the outside of the inner bowl 20; and an interior sealing member 76 connected to the lid separation preventing member 72 and the bowl outside separation preventing member 74, extended toward the inside of the inner bowl 20, and mounted between the inner bowl 20 and the stopper protrusion 13.

A plurality of sealing protrusions 78 protruding from the side of the interior sealing member 76 facing the inner bowl 20 is mounted to get in contact with the side of the inner bowl 20 so as to prevent movement of the inside air and the outside air of the inner bowl 20.

The sealing protrusion 78 has a triangular cross section, but the present invention is not limited to the above and may have one of various cross section forms.

Because the lid separation preventing member 72 is inserted into the stopper protrusion 13 and the bowl outside separation preventing member 74 is caught to the edge of the inner bowl 20, in a case that low pressure is formed inside the inner bowl 20, it prevents that the vacuum packing unit 70 moves to the inside of the inner bowl 20 so as to enhance sealability of the electric rice cooker 1 and preservation performance of the food.

The valve unit 80 mounted on the upper casing unit 10 includes the main valve 81 for controlling discharge pressure of steam by rotation of a valve handgrip 86 and the subsidiary valve 140 for automatically discharging steam when pressure is above set pressure.

The main valve 81 can control pressure of discharged steam to thereby provide cooking environment suitable for various foods or a user's tastes.

Furthermore, because the subsidiary valve 140 automatically discharges steam above the set pressure exceeding discharge pressure of the main valve 81, it prevent explosion of the electric rice cooker 1 or safety accidents.

The main valve 81 and the subsidiary valve 140 are mounted on the upper casing unit 10, and the installation location and the structure of the valves may be varied within the technical scope to automatically discharge the inside steam of the electric rice cooker 1 to the outside.

The main valve 81 is mounted by passing through the upper casing unit 10, rotates the housing member 85 by the valve handgrip 86 and varies the height of a fixing member 90 to thereby control discharge pressure of steam. After predetermined pressure is discharged, a first sealing plate 124 is automatically seated on a second sealing plate 132 to thereby keep a sealed state of the inner bowl 20 in which food is cooked.

The main valve 81 has the valve handgrip 86 protrudingly formed at one side of an upper body 87. In order to control pressure of the electric rice cooker 1, the user turns the valve handgrip 86.

A lower hook 89 is disposed at the other side of the upper body 87 of a cylindrical form which is connected with the valve handgrip 86, and a height controlling unit 88 having teeth of which height is gradually increased is disposed inside a housing member 85.

The height controlling unit 88 may have one of various shapes within the technical scope to gradually increase or decrease the height of the teeth by rotation of the housing member 85.

The fixing member 90 mounted inside the housing member 85 includes: a fixing body 92 located inside the upper body 87; fixing protrusions 94 protruding above the fixing body 92 and getting in contact with the height controlling unit 88; and a side protrusion 96 protruding toward the lower side of the fixing body 92.

The fixing protrusions 94 may be formed in one of various shapes with in the technical scope that the fixing protrusions 94 interlock with the teeth of the height controlling unit 88 and vertically move together with the fixing body 92.

The fixing protrusions 94 are protrudingly formed at both sides of the upper part of the fixing member 90, and the height controlling units 88 to which the fixing protrusions are caught are also disposed at both sides within an operational scope that the fixing protrusions 94 are rotated.

That is, when the fixing protrusions 94 are mounted at both sides, the height controlling units 88 are mounted along an arc shape in a zone between the right and left sides where the fixing protrusions 94 are rotated.

The height of the height controlling unit 88 is gradually increased or decreased such that the fixing protrusions 94 have the same height.

The height controlling unit 88 has the teeth having the triangular cross section form, and the fixing protrusions 94 which will be caught to the height controlling unit 88 also have a wedge shape.

A spring member 100 is disposed inside a lower part of the fixing member 90, and a pressure member 105 is elastically pressurized in the downward direction by the spring member 100.

The pressure member 105 according to the preferred embodiment includes: a round plate type support plate 107 pressurized in the downward direction; and a vertical bar 109 protruding from the center of the support plate 107 upwardly and passing through the center of the fixing member 90 and the housing member 85 to indicate a pressure state signal.

The vertical bar 109 protrudes toward the outside of the housing member 85 so that the user can see it, and indicates the pressure state signal of the electric rice cooker 1.

The vertical bar 109 has a hollow inside to prevent deformation when it is injection-molded and to reduce material costs.

The spring member 100 for elastically supporting the fixing member 90 is mounted between the fixing member 90 and the support plate 107.

A movement member 110 located inside the upper body 87 together with the fixing member 90 may have one of various shapes within the technical scope that the support plate 107 of the pressure member 105 is seated inside the movement member 110 and pressure force by the spring member 100 is transferred to the movement member 110 so as to press an upper sealing member 120.

The movement member 110 on which the support plate 107 of the pressure member 105 is seated includes a cylindrical movement body 112 of which upper side is opened.

The side protrusion 96 of the fixing member 90 is caught and mounted to a guide groove 114 formed in the inner surface of the movement member 110, such that the fixing member 90 is restricted in rotation and can move just in the vertical direction.

Moreover, a guide protrusion (not shown) and a guide rail (not shown) are respectively formed on facing surfaces between the movement member 110 and the housing member 85, such that the movement member 110 is restricted in rotation and can move just in the vertical direction.

The movement body 112 has a stopper protrusion 116 disposed at the lower portion thereof in such a way that an inner protrusion 122 of the upper sealing member 120 is inserted and caught to the stopper protrusion 116.

Because the stopper protrusion 116 has a hollow inside and the inner protrusion 122 is inserted and caught to the stopper protrusion 116, the upper sealing member 120 vertically moves together with the movement member 110.

The upper sealing member 120 includes the first sealing plate 124 disposed at the lower side thereof, and the lower sealing member 130 includes the second sealing plate 132 corresponding to the first sealing plate 124.

The first sealing plate 124 is formed in a downwardly concave shape, and an opening and closing protrusion 126 of a spherical form protrudes from the center of the first sealing plate 124.

The second sealing plate 132 which gets in contact with the first sealing plate 124 is formed in an upwardly concave shape, and both sides of the first sealing plate 124 is pressed in a state where they get in contact with both sides of the second sealing plate 132 so as to first keep a sealed state.

At the same time, the opening and closing protrusion 126 shields a pressure discharge hole 134 disposed in the lower sealing member 130 so as to second keep the sealed state.

The lower sealing member 130 located around the upper part of the pressure discharge hole 134 has a sealing protrusion 133 having an angular edge. Because the spherical opening and closing protrusion 126 comes into contact with the upper side of the sealing protrusion 133 to be in a line contact state, it can effectively prevent movement of air.

The upper sealing member 120 and the lower sealing member 130 are molded of a rubber material or a silicon material. Alternatively, the upper sealing member 120 and the lower sealing member 130 may be made of an elastic material.

The lower sealing member 130 is mounted on the inner lid 11 of the upper casing unit 10 and the pressure discharge hole 134 which communicates with the inside of the inner bowl 20 is disposed in the middle of the lower sealing member 130.

A screw coupling member 136 is disposed around the upper side of the lower sealing member 130. Because the screw coupling member 136 is coupled to a cover member 160 which is fixed above the inner lid 11, the lower sealing member 130 is mounted in the first connection hole 12 formed in the inner lid 11.

Because the cover member 160 mounted inside the upper casing unit 10 encloses an outer surface of the housing member 85, it guides the housing member 85 to rotate stably.

The cover member 160 includes: a pipe-shaped cover body 162 mounted between the inner lid 11 and the lid case 18; an inner support member 164 protruding toward the inside of the cover body 162; and rotation guiding grooves 166 which forms an arc-shaped groove in the inner support member 164.

The rotation guiding grooves 166 are formed in an arc shape in such a way that the lower hook 89 of the housing member 85 is inserted to be rotated, and are respectively formed at both sides of the inner support member 164.

When the inside steam of the electric rice cooker 1 is above the set pressure, the upper sealing member 120 is lifted up, such that the steam is discharged to the outside of the main valve 81.

In order to discharge out steam through the main valve 81, a side steam discharge groove 170 is formed in the movement body 112 of the movement member 110 in the vertical direction.

A plurality of the side steam discharge grooves 170 may be formed unless they are not interfered with the support plate 107 of the pressure member 105.

A first central steam discharge groove 171 is formed in the fixing body 92 of the fixing member 90 in order to discharge steam.

The first central steam discharge groove 171 is formed along the circumference of an inner through hole in which the vertical bar 109 is mounted. The first central steam discharge groove 171 forms a path for moving air between the outside of the vertical bar 109 and the fixing body 92.

A second central steam discharge groove 172 is formed in the upper body 87 of the housing member 85 in order to discharge steam.

The second central steam discharge groove 172 is formed along the circumference of a hole in which the vertical bar 109 is mounted. The second central steam discharge groove 172 forms a path for moving air between the outside of the vertical bar 109 and the upper body 87.

The steam discharged through the pressure discharge hole 134 is discharged out by passing through the side steam discharge groove 170 formed in the movement member 110, the first central steam discharge groove 171 formed in the fixing member 90 and the second central steam discharge groove 172 formed in the housing member 85 in order.

In the meantime, the subsidiary valve 140 may be one of various valve devices within the technical scope that the valve can automatically discharge steam when the set pressure exceeds the discharge pressure of the main valve 81.

The subsidiary valve 140 includes: a body member 141 fixed at the upper casing unit 10; a cylinder member 150 moving up and down inside the body member 141; and an elastic member 155 downwardly pressing the cylinder member 150 to prevent movement of air through the body member 141.

The body member 141 includes: a steam inlet 144 communicating with the inside of the inner bowl 20; an outlet 146 communicating with the outside of the upper casing unit 10; and an operation space 148 communicating with the steam inlet 144 and the outlet 146.

The body member 141 may be a single member, and if necessary, may be transformed into various shapes.

The body member 141 according to the preferred embodiment which includes the outlet 146 and the operation space 148 further includes: a nut-combined valve 142 communicated with the upper side of the upper casing unit 10; and a sealing and fastening bolt 143 screw-coupled with the nut-combined valve 142 and communicated with the lower side of the upper casing unit 10.

The sealing and fastening bolt 143 is formed inside the steam inlet 144 in such a way that the lower side of the sealing and fastening bolt 143 is caught to the inner lid 11 and the upper side of the sealing and fastening bolt 143 is screw-coupled to the nut-combined valve 142 after passing through the inner lid 11.

The cylinder member 150 mounted in the operation space 148 slides along the operation space 148 according to steam pressure of the electric rice cooker 1, and may have one of various shapes within the technical scope to opening and close the steam inlet 144.

The cylinder member 150 is pressed downwardly toward the inner bowl 20 by the elastic member 155 of which both sides are supported to the body member 141 and the cylinder member 150.

The elastic member 155 presses the cylinder member 150 toward the lower side, where the steam inlet 144 is formed, by elastic force, and one of various pressing devices may be used within such a technical scope.

Hereinafter, referring to the attached drawings, an operational state of the electric rice cooker 1 according to the preferred embodiment of the present invention will be described in detail.

After the upper casing unit 10 is joined to the upper side of the lower casing unit 40, the upper heater unit 60 and the lower heater unit 65 are operated at the same time to heat the inside of the inner bowl 20.

The upper heater unit 60 and the lower heater unit 65 have different heating temperature ranges according to food ingredients to be cooked, and hence, they can evenly heat the upper part and the lower part of the food ingredients and reduce cooking time.

Because heating temperature of the upper heater unit 60 is above 100 degrees, the electric rice cooker 1 restrain convection current of the food ingredient and air contained in the inner bowl 20 so as to prevent that the food ingredients are boiled over the inner bowl 20.

The lower heater unit 65 heats the air of the first heat sustaining space 31 and heats the hot plate member 50 at the same time.

The air of the first heat sustaining space 31 uniformly heats the outside of the inner bowl 20, and the hot plate member 50 additionally heats the lower side of the inner bowl 20 to thereby reduce cooking time.

When the air of the first heat sustaining space 31 is heated above the set temperature, the bimetal member 33 mounted on the heat insulating outer bowl 30 is operated to open the connection holes 32.

The heated air of the first heat sustaining space 31 is discharged out through the connection holes 32 of the heat insulating outer bowl 30 and the air supply ports 41 of the lower casing unit 40, and the air outside the electric rice cooker 1 is introduced into the first heat sustaining space 31.

When the air inside the first heat sustaining space 31 lowers less than the set temperature, the bimetal member 33 returns to its original position so as to shield the connection holes 32 of the heat insulating outer bowl 30.

The air of the second heat sustaining space 15 disposed at the upper side of the inner lid 11 is heated by the upper heater unit 60, and the heat reflection plate 16 on which the upper heater unit 60 is formed may have a bimetal member which automatically discharges the air heated over the set temperature.

While the upper casing unit 10 of the electric rice cooker 1 is closed, an inner stopper protrusion member of the vacuum packing unit 70 is mounted to come into contact with the stopper protrusion 13 and the inner bowl 20.

Because the lid separation preventing member 72 is inserted and caught to the stopper protrusion 13 and the bowl outside separation preventing member 74 is caught to the outside edge of the inner bowl 20, even though the inside pressure of the inner bowl 20 is low pressure, it can prevent that the vacuum packing unit 70 is separated toward the inside of the inner bowl 20.

Additionally, elastic force of the spring member 100 which is controlled when the user turns the valve handgrip 86 is transferred to the movement member 110 through the pressure member 105 so as to control the degree that the upper sealing member 120 connected with the movement member 110 is pressed downwardly.

The cylinder member 150 of the subsidiary valve 140 is also pressed down by the elastic member 155 so as to prevent that steam inside the electric rice cooker 1 is discharged out less than the set pressure.

Pressure of the steam discharged through the main valve 81 can be controlled when the user turns the valve handgrip 86.

When the user turns the valve handgrip 86, the fixing protrusion 94 which is caught to the height controlling unit 88 gradually increased or decreased in height is moved upwardly or downwardly.

When the fixing member 90 moves up and down, the spring member 100 is compressed more than the set value or is released from the compression.

Therefore, the degree that the upper sealing member 120 is compressed to the lower sealing member is controlled, and as shown in FIG. 3, the fixing member 90 moves to approach the housing member 85. In a case that the spring member 100 is not pressed above the set value, as shown in FIG. 5, the steam which lifts up the upper sealing member 120 by steam pressure inside the electric rice cooker 1 is discharged out.

Moreover, as shown in FIG. 4, the fixing member 90 moves in the direction to be farther away from the housing member 85, and when the spring member 100 is pressed above the set value, because compression force of the spring member 100 is greater than the steam pressure inside the electric rice cooker 1, it prevents that steam or air inside the electric rice cooker 1 is discharged out and prevents that the outside air is introduced into the electric rice cooker 1.

Furthermore, in order to prevent a damage of the electric rice cooker 1 or safety accidents caused by pressure exceeding the set value due to an abnormal operation of the main valve 81, when pressure exceeds the set value, the subsidiary valve 140 makes the cylinder member 150 move upwardly by steam pressure so as to discharge steam.

According to the configuration, the electric rice cooker 1 according to the preferred embodiment of the present invention can control steam pressure discharged when the valve handgrip 86 is rotated, thereby providing various cooking conditions according to the user's tastes or kinds of foods.

Furthermore, the electric rice cooker 1 according to the embodiment of the present invention can prevent movement of air inside and outside the electric rice cooker 1 through the main valve 81 or the subsidiary valve 140 for discharging steam and keep a low pressure and low vacuum state which is formed after the inside air of the electric rice cooker 1 is cooled down at a high temperature state while storing food therein, thereby enhancing food preserving performance.

While the present invention has been particularly shown and described with reference to the exemplary embodiment thereof, it will be understood by those of ordinary skill in the art that various changes and modifications may be made therein without departing from the technical idea and scope of the present invention.

Additionally, in this specification, the electric rice cooker for home use is described as an example, but the electric rice cooker according to the present invention can be used for business use, for industrial use and for other various uses.

Therefore, the technical protection scope of the present invention should be defined by the following claims.

1. An electric rice cooker comprising:
an upper casing unit (10) on which a valve unit (80) for discharge pressure is mounted;
an inner bowl (20) which is arranged beneath the upper casing unit (10) and in which food to be cooked is contained;
a heat insulating outer bowl (30) enclosing an outer surface of the inner bowl (20) and having a first heat sustaining space (31) formed between the inner bowl (20) and the outer bowl (30);
a lower casing unit (40) enclosing an outer surface of the heat insulating outer bowl (30) and having a plurality of air supply ports (41);
a lower heating unit (65) interposed between the heat insulating outer bowl (30) and the inner bowl (20) for generating heat;
an upper heater unit (60) arranged inside the upper casing unit (10) to operate together with the lower heater unit (65);
a vacuum packing unit (70) interposed between the upper casing unit (10) and the inner bowl (20) to cut off an air flow; and
a stopper protrusion (13) which has a stopper groove (14) formed along an edge of the upper casing unit (10) facing the inner bowl (20) in such a way that the vacuum packing unit (70) is inserted and caught at the stopper groove (14),
wherein the vacuum packing unit (70) comprises:
a lid separation preventing member (72) inserted and caught to the stopper groove (14);
a bowl outside separation preventing member (74) which extends from the lid separation preventing member (72) and is caught to the outside of the inner bowl (20); and
an interior sealing member (76) connected to the lid separation preventing member (72) and the bowl outside separation preventing member (74), extended toward the inside of the inner bowl (20), and mounted between the inner bowl (20) and the stopper protrusion (13).

2. The electric rice cooker according to claim 1, wherein the upper casing unit (10) comprises:
an inner lid (11) which is mounted above the inner bowl (20) and has the stopper protrusion (13) disposed at the edge thereof;
a heat reflection plate (16) which is spaced apart from the inner lid (11) to form a second concurrent heating space (15) and has a lower side to which the upper heater unit (60) is mounted;
a heat insulating plate (17) enclosing an outer surface of the heat reflection plate (16) to prevent heat transfer; and
a lid case (18) enclosing an outer surface of the heat insulating plate (17).

3. The electric rice cooker according to claim 1, wherein the vacuum packing unit (70) comprises a plurality of sealing protrusions (78) which protrudes from the side of the interior sealing member (76) facing the inner bowl (20) and is mounted to get in contact with the side of the inner bowl (20).

4. The electric rice cooker according to claim 1, wherein the valve unit (80) comprises:
a main valve (81) which is mounted by passing through the upper casing unit (10), rotates the housing member (85) by the valve handgrip (86), varies the height of a fixing member (90) to thereby control discharge pressure of steam, and is automatically seated on a second sealing plate (132) auto after discharge of predetermined pressure to thereby keep a sealed state of the inner bowl (20).

5. The electric rice cooker according to claim 4, wherein the main valve (81) comprises:
a height controlling unit (88) having teeth of which height is gradually increased is disposed inside the housing member (85) in such a way that the valve handgrip (86) protrudes from one side to control pressure;
fixing protrusions (94) mounted inside the housing member (85) and protrudingly formed from the fixing member (90) to interlock with the teeth of the height controlling unit (88);
a pressure member (105) including a support plate (107) pressurized downwardly by a spring member (100) disposed inside the fixing member (90) and a vertical bar (109) upwardly protruding from the center of the support plate (107) and passing through the center of the fixing member (90) to indicate a pressure state signal;
a movement member (110) in which the pressure member (105) is seated in such away as to receive pressing power by the spring member (100) and which is mounted inside the housing member (85);
an upper sealing member (120) which is fixed at the lower side of the movement member (110) to be moved according to an up and down movement of the movement member (110) and has a first sealing plate (124) disposed at the lower side; and
a lower sealing member (130) which is located at the lower side of the upper sealing member (120) and has pressure discharge hole (134) communicating with the inside of the inner bowl (20),
wherein the steam discharged through the pressure discharge hole (134) is discharged out by passing through a side steam discharge groove (170) formed in the movement member (110), a first central steam discharge groove (171) formed in the fixing member (90) and a second central steam discharge groove (172) formed in the housing member (85) in order.

6. The electric rice cooker according to claim 4, wherein the valve unit (80) comprises a subsidiary valve (140) for automatically discharging steam at set pressure exceeding discharge pressure of the main valve (81), and
wherein the subsidiary valve (140) comprises:
a body member (141) which is fixed at the upper casing unit (10) and includes a steam inlet (144) communicating with the inside of the inner bowl (20), an outlet (146) communicating with the outside of the upper casing unit (10), and an operation space (148) communicating with the steam inlet (144) and the outlet (146);
a cylinder member (150) sliding along the operation space (148) according to steam pressure; and
an elastic member (155) of which both sides are supported to the body member (141) and the cylinder member (150) and which downwardly presses the cylinder member (150) by a predetermined elastic force toward the lower side where the steam inlet (144) is formed.

7. The electric rice cooker according to claim 1, further comprising:
a plurality of connection through holes (32) formed in the heat insulating outer bowl (30); and
a bimetal member (33) varied in length according to a change in temperature of the first heat sustaining space (31) to open and close the connection hole (32).

8. The electric rice cooker according to claim 1, further comprising:
a hot plate member (50) which is mounted between the lower heater unit (65) and the inner bowl (20) and distributes heat of the lower heater unit (65) to heat the lower side of the inner bowl (20).
